(19) United States
(12) Patent Application Publication
(10) Pub. No.: US 2023/0238575 A1
(43) Pub. Date: Jul. 27, 2023

(54) Elastomer/Inorganic Hybrid Solid-State Electrolytes, Lithium Batteries Containing Same, and Production Processes

(71) Applicant: Global Graphene Group, Inc., Dayton, OH (US)

(72) Inventors: Aruna Zhamu, Springboro, OH (US); Bor Z. Jang, Centerville, OH (US)

(73) Assignee: Global Graphene Group, Inc., Dayton, OH (US)

(21) Appl. No.: 17/648,856

(22) Filed: Jan. 25, 2022

(51) Int. Cl. H01M 10/0565; H01M 10/0525; H01M 10/0562; H01M 10/44

(52) U.S. Cl. CPC H01M 10/0565; H01M 10/0525; H01M 10/0562; H01M 10/44; H01M 2300/0082; H01M 2300/0085; H01M 2300/0071

(57) ABSTRACT

A hybrid solid electrolyte particulate for use in a rechargeable lithium battery cell, wherein said particulate comprises one or more than one inorganic solid electrolyte particles encapsulated by a shell of elastic polymer electrolyte wherein (i) the hybrid solid electrolyte particulate has a lithium-ion conductivity from 10⁻⁶ S/cm to 5×10⁻² S/cm and both the inorganic solid electrolyte and the elastic polymer electrolyte individually have a lithium-ion conductivity no less than 10⁻⁶ S/cm; (ii) the elastic polymer electrolyte-to-inorganic solid electrolyte ratio is from 1/100 to 100/1 or the elastic polymer electrolyte shell has a thickness from 1 nm to 10 μm; and (iii) the elastic polymer electrolyte has a recoverable elastic tensile strain from 5% to 1,000%. Also provided is a lithium-ion or lithium metal cell containing multiple hybrid solid electrolyte particulates in the anode, cathode and/or the separator. Processes for producing hybrid solid electrolyte particulates are also disclosed.

### FIELD

The present disclosure provides a fire/flame-resistant hybrid electrolyte and lithium batteries (lithium-ion and lithium metal batteries) containing such an electrolyte. The electrolytes can be implemented in an anode (negative electrode), a cathode (positive electrode), and/or a separator in a battery cell.

### BACKGROUND

Rechargeable lithium-ion (Li-ion) and lithium metal batteries (e.g., lithium-sulfur, lithium selenium, and Li metal-air batteries) are considered promising power sources for electric vehicle (EV), hybrid electric vehicle (HEV), and portable electronic devices, such as lap-top computers and mobile phones. Lithium as a metal element has the highest lithium storage capacity (3,861 mAh/g) compared to any other metal or metal-intercalated compound as an anode active material (except Li_{4.4}Si, which has a specific capacity of 4,200 mAh/g). Hence, in general, Li metal batteries (having a lithium metal anode) have a significantly higher energy density than lithium-ion batteries (having a graphite anode).

However, the liquid electrolytes used for all lithium-ion batteries and all lithium metal secondary batteries pose some safety concerns. Most of the organic liquid electrolytes can cause thermal runaway or explosion problems. To mitigate these risks, one can replace organic liquid electrolytes with inorganic solid electrolytes, which feature higher thermal stability and are not susceptible to leakage. This replacement affords high-energy-density all-solid-state batteries (ASSBs), which have attracted much attention, as exemplified by many recent attempts to use solid electrolytes in combination with high-voltage cathodes, high-capacity sulfur electrodes, and Li metal anodes for improved energy densities and safety.

Solid state electrolytes are commonly believed to be safe in terms of fire and explosion proof. Solid state electrolytes can be divided into organic (polymeric), inorganic, organic-inorganic composite electrolytes. However, the lithium-ion conductivity of well-known organic polymer solid state electrolytes, such as poly(ethylene oxide) (PEO), polypropylene oxide (PPO), poly(ethylene glycol) (PEG), and poly(acrylonitrile) (PAN), is typically low (<10⁻⁵ S/cm), although there are solid polymeric electrolytes that exhibit higher conductivity.

Although the inorganic solid-state electrolyte (e.g., garnet-type and metal sulfide-type) can exhibit a high conductivity (from 5×10⁻⁵ to 10⁻² S/cm), the interfacial impedance or resistance between the inorganic solid-state electrolyte and the electrode (cathode or anode) is high, often leading to unsatisfactory power densities. Further, the traditional inorganic ceramic electrolyte is very brittle and has poor film-forming ability and poor mechanical properties. Furthermore, many of these materials cannot be cost-effectively manufactured into a thin separator.

Among the various types of inorganic solid electrolytes (e.g., sulfide-, oxide-, hydride-, and halide-based) developed to date, the sulfide-based ones feature high conductivities and interface formability, and are therefore particularly well suited for ASSBs. In particular, sulfide electrolytes with Li₁₀GeP₂S₁₂, argyrodite, and Li₇P₃S₁₁-type crystal structures have high conductivities (>10⁻³ S/cm and some >10⁻² S/cm), comparable to those of liquid electrolytes. Sulfide electrolytes are easily deformed by pressing at room temperature, allowing one to form favorable electrode/electrolyte interfaces with high contact areas, and ensure sufficient ion conduction. However, processing of sulfide electrolyte-based electrodes and separators using the common slurry coating process can involve emission of undesirable chemical species (e.g., toxic hydrogen sulfide). Further, the volume changes of the electrode active materials during charge/discharge tend to induce local contact losses at the electrode/electrolyte interfaces in an ASSB.

Another serious drawback of implementing the inorganic solid electrolyte (ISE) in an electrode (anode or cathode) is the notion that it would normally take a high loading of the ISE particles (typically 30-60% by volume) to meet the two essential conditions: (i) the electrolyte must form a contiguous phase through which lithium ions can travel to reach individual particles of an electrode (anode or cathode) active material; and (ii) substantially each and every electrode active material particle (e.g., graphite or Si particles in the anode or lithium metal oxide particles in the cathode) must be in physical contact with this contiguous electrolyte phase. This implies that the proportion of the electrode active material responsible for the lithium-ion storage capability in an electrode would be reduced to less than 40-70%, leading to a significantly reduced energy density of the resulting battery cell. It is thus essential to minimize the amounts of the electrolyte and other non-active materials, such as conductive filler and binder, in an electrode.

The most series issue associated with certain solid-state electrolytes (e.g., sulfide solid-state electrolytes, SSEs) is the observation that these electrolytes have a narrow electrochemical stability window when compared with oxides and halides. Such a narrow electrochemical stability window is a major practical disadvantage of sulfide SSEs since the electrolyte must be stable over a wide range of lithium potentials between the anode chemical potential (0 eV/atom vs. Li/Li⁺) and the potential set by the cathode, which is near 4.0 eV/atom vs. Li/Li⁺ for some typical cathode active materials.

Hence, a general object of the present disclosure is to provide a safe, flame/fire-resistant, solid-state electrolyte system for a rechargeable lithium cell that overcomes most or all of the aforementioned issues. Desirably, the electrolyte is also compatible with existing battery production facilities. It is a further object of the present disclosure to provide an electrolyte that occupies a minimal proportion of the total volume of an electrode, yet still forms a contiguous phase in the electrode and is in physical contact with substantially all the electrode active material particles.

### SUMMARY

The present disclosure provides a hybrid solid electrolyte particulate (or multiple particulates) for use in a rechargeable lithium battery cell, wherein the particulate comprises one or more than one inorganic solid electrolyte (ISE) particles encapsulated by a shell of elastic polymer electrolyte wherein (i) the hybrid solid electrolyte particulate has a lithium-ion conductivity from 10⁻⁶ S/cm to 5×10⁻² S/cm and both the inorganic solid electrolyte and the elastic polymer electrolyte individually have a lithium-ion conductivity no less than 10⁻⁶ S/cm; (ii) the elastic polymer electrolyte-to-inorganic solid electrolyte ratio is from 1/100 to 100/1 or the elastic polymer electrolyte shell has a thickness from 1 nm to 10 μm; and (iii) the elastic polymer electrolyte has a recoverable elastic tensile strain from 5% to 1,000%.

The encapsulating polymer shell preferably has a thickness from 1 nm to 10 μm (preferably from 2 nm to 2 μm, more preferably less than 1 μm, and most preferably less than 500 nm). In certain embodiments, the inorganic solid electrolyte material particles are preferably from 5 nm to 20 μm in diameter, more preferably from 20 nm to 10 μm, and most preferably smaller than 5 μm).

Preferably, the hybrid electrolyte particle has a lithium-ion conductivity from 10⁻⁵ S/cm to 5×10⁻² S/cm. Preferably, the polymer electrolyte alone (without the ISE) has a lithium-ion conductivity from 10⁻⁸ S/cm to 5×10⁻² S/cm, more typically from 10⁻⁶ S/cm to 10⁻² S/cm, more preferably greater than 10⁻⁵ S/cm, furthermore preferably greater than 10⁻⁴ S/cm, and most preferably greater than 10⁻³ S/cm.

Also provided is a lithium-ion or lithium metal cell containing multiple hybrid solid electrolyte particulates in the anode, cathode and/or the separator.

In certain embodiments, the inorganic solid electrolyte material is selected from an oxide type, sulfide type (including, but not limited to, the thio-LISICON type, glass-type, glass ceramic-type, and argyrodite-type sulfide electrolyte), hydride type, halide type, borate type, phosphate type, lithium phosphorus oxynitride (LiPON), garnet-type, lithium superionic conductor (LISICON) type, sodium superionic conductor (NASICON) type, or a combination thereof.

In certain embodiments, the elastic polymer electrolyte comprises a material selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyphosphazene, polyurethane, urethane-urea copolymer, a copolymer thereof, a sulfonated version thereof, or a combination thereof.

The elastic polymer electrolyte may further comprise a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, poly(alkylsiloxane), poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyacrylamide, a polyionic liquid, polymerized 1,3-dioxolane, polyepoxide ether, polysiloxane, poly(dimethyl siloxane), poly(alkyl siloxane), poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a crosslinked polymer containing chains of ethylene glycol phenyl ether acrylate) (PEGPEA) or ethoxylated trimethyl propyl triacrylate (ETPTA), poly(phosphate), poly(phosphonate), poly(phosphinate), poly(phosphite) poly(phosphine oxide), poly(phosphonic acid), poly(phosphorous acid), poly(phosphite), poly(phosphoric acid), poly(phosphazene), a chemical derivative thereof, a copolymer thereof, a sulfonated derivative thereof, or a combination thereof, wherein the ion-conducting polymer and the elastic polymer form a polymer blend, a copolymer, a crosslinked network of chains, a semi-interpenetrating network, or a simultaneous interpenetrating network.

In some preferred embodiments, the polymer electrolyte shell further comprises a lithium salt (e.g., 0.1%-60% by weight of a lithium salt dispersed in the polymer electrolyte). The lithium salt is preferably selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiGH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0⁻¹, y=1⁻⁴, or a combination thereof.

In some embodiments, the rechargeable lithium cell has the following features:
1) the hybrid solid electrolyte particulates comprise a 1^{st} elastic polymer electrolyte encapsulating inorganic solid electrolyte particles;
2) the anode comprises multiple anode particulates comprising anode active material particles encapsulated by a 2^{nd} solid electrolyte polymer (preferably a 2^{nd} elastic polymer electrolyte), wherein the 1^{st} elastic polymer electrolyte and the 2^{nd} solid electrolyte polymer are identical or different in chemical composition or structure; and
3) the hybrid solid electrolyte particulates and the anode particulates, along with an optional conductive additive, are compacted or consolidated to form the anode, wherein the 1^{st} elastic polymer electrolyte and the 2^{nd} solid electrolyte polymer form a contiguous pathway for lithium ion transport.

The present disclosure also provides an anode that has the above defined features.

In some embodiments, the rechargeable lithium cell has the following features:
1) the hybrid solid electrolyte particulates comprise a 1^{st} elastic polymer electrolyte encapsulating inorganic solid electrolyte particles;
2) the cathode comprises multiple cathode particulates each comprising cathode active material particles encapsulated by a 2^{nd} solid electrolyte polymer (preferably an elastic polymer electrolyte), wherein the 1^{st} elastic polymer electrolyte and the 2^{nd} solid electrolyte polymer are identical or different in chemical composition or structure; and
3) the hybrid solid electrolyte particulates and the cathode particulates, along with an optional conductive additive, are compacted or consolidated to form the cathode, wherein the 1^{st} elastic polymer electrolyte and the 2^{nd} solid electrolyte polymer, in combination, form a contiguous pathway for lithium ion transport.

The present disclosure also provides a cathode that has the above defined features.

The processes that can be used to produce the hybrid solid electrolyte particulates are briefly described now, but will be further discussed later. For instance, for those elastic polymers that are soluble in a liquid solvent (e.g., linear-chain or branched polymers, such as thermoplastic elastomers), one can begin by dissolving a polymer (optionally but preferably, along with a desired amount of a lithium salt) to form a polymer/solvent liquid solution. A desired amount of fine particles (e.g., 5 nm to 10 μm in diameter) of an inorganic solid electrolyte (ISE) are then dispersed into the liquid solution to form a slurry. The slurry may then be formed into hybrid particulates (elastic polymer electrolyte-encapsulated ISE secondary particles) using any known particle-forming procedure combined with solvent removal (e.g., spray-drying).

In some other examples, the polymer electrolyte as the encapsulating shell in the hybrid solid electrolyte particulate comprises a polymer that is a polymerization or crosslinking product of a reactive additive comprising (i) a monomer or oligomer that is polymerizable and/or cross-linkable, (ii) an initiator and/or curing agent, and (iii) a lithium salt (optional but desirable), wherein the monomer/elastomer occupies from 1% to 99% by weight based on the total weight of the reactive additive.

In these examples, a desired amount of fine particles of an inorganic solid electrolyte may be dispersed in the reactive additive to form a reactive slurry. The slurry may then be formed into secondary particles having ISE particles being embraced with a thin layer of reactive additive. This is followed by polymerization and/or crosslinking to form the hybrid solid electrolyte particulates, wherein each particulate comprises one or more than one primary particles of an ISE being encapsulated by a substantially solid polymer electrolyte. Preferably, at least 30% by weight of the monomer/oligomer is polymerized/crosslinked; more preferably >50%, further preferably >70%, and most preferably >99% is polymerized/crosslinked.

The elastic polymer typically contains a network of crosslinked chains having a degree of crosslinking that imparts a recoverable tensile strain from 5% to 1,000%. The elastic polymer can be a thermoplastic elastomer that contains physical entanglements or phase domains holding polymer chains together when the polymer is being stressed.

In certain embodiments, the elastic polymer shell layer comprises an elastomer or rubber selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, epichlorohydrin rubber, polyacrylic rubber, silicone rubber, polysiloxane, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyurethane, urethane-urea polymer, a copolymer thereof, a chemical derivative thereof, a sulfonated version thereof, or a combination thereof.

The elastomer or rubber may be selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

In certain embodiments, the polymerizable/cross-linkable monomer/oligomer is chemically bonded to the chains selected from the group consisting of vinylene carbonate, ethylene carbonate, fluoroethylene carbonate, ethylene glycol phenyl ether acrylate) (PEGPEA), ethoxylated trimethyl propyl triacrylate (ETPTA), tetrahydrofuran (THF), vinyl sulfite, vinyl ethylene sulfite, vinyl ethylene carbonate, 1,3-propyl sultone, 1,3,5-trioxane (TXE), 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones (including alkyl siloxanes, etc.), sulfides, dinitriles, acrylonitrile (AN), sulfates, siloxanes, silanes, N-methylacetamide, acrylates, ethylene glycols, phosphates, phosphonates, phosphinates, phosphines, phosphine oxides, phosphonic acids, phosphorous acid, phosphites, phosphoric acids, phosphazene compounds, derivatives thereof, and combinations thereof. Such chemical bonding may be in the form of copolymerization, grafting, cross-linking, etc.

It is uniquely advantageous to be able to fully polymerize/crosslink the monomer/oligomer once the liquid electrolyte (having a lithium salt dissolved in the monomer/oligomer liquid or a crosslinked polymer in a solution) is used to form a shell that embraces and encapsulating single or multiple inorganic solid electrolyte (ISE) particles. The hybrid solid electrolyte particulates (secondary particles) can then be utilized in the anode, the cathode, and/or the separator. For instance, multiple hybrid solid electrolyte particulates may be formed (e.g., melt fusion followed by solidification) into an ion-conducting membrane as a separator, preferably having a thickness from 10 nm to less than 100 μm. Multiple hybrid solid electrolyte particulates may also be mixed with a desired amount of an anode active material (e.g., graphite, Si, SiO particles) to form an anode (negative electrode) using a conventional electrode fabrication procedure (e.g., slurry coating process). Similarly, multiple hybrid solid electrolyte particulates may also be mixed with a desired amount of a cathode active material (e.g., lithium iron phosphate and lithium metal oxide particles) to form a cathode (positive electrode) using a conventional electrode fabrication procedure (e.g., slurry coating process). This strategy enables us to achieve several desirable attributes of the resultant hybrid electrolyte, electrodes, separator, and cell:
1) no liquid electrolyte leakage issue in a battery cell;
2) adequate amount of lithium salt dispersed in the elastic polymer electrolyte shell to impart a good lithium-ion conductivity to the polymer shell;
3) good lithium-ion conductivity of the all-solid hybrid electrolyte particles;
4) eliminated flammability of the battery cell;
5) good mixing of the electrolyte particles with the anode or cathode active material particles, enabling significantly reduced interfacial impedance and improved utilization of the active material (hence, higher energy density);
6) elasticity of the encapsulating shell facilitates good contact between the hybrid electrolyte particulates and anode or cathode active material particles during battery charging or discharging; and
7) processing ease, including compatibility with current lithium-ion battery production processes and equipment.

These features provide significant utility value since most of the organic solvents commonly used in the lithium battery are known to be volatile and flammable, posing a fire and explosion danger. Further, current solid-state electrolytes are not compatible with existing lithium-ion battery manufacturing equipment and processes.

In certain preferred embodiments, the polymer electrolyte shell further comprises a flame retardant selected from an organic phosphorus compound, an inorganic phosphorus compound, a halogenated derivative thereof, or a combination thereof. The organic phosphorus compound or the inorganic phosphorus compound preferably is selected from the group consisting of phosphates, phosphonates, phosphonic acids, phosphorous acids, phosphites, phosphoric acids, phosphinates, phosphines, phosphine oxides, phosphazene compounds, derivatives thereof, and combinations thereof. These compounds may be polymerized to become part of the encapsulating shell.

Preferably, the lithium salt occupies 0.1%⁻⁵⁰% by weight and the crosslinking agent and/or initiator occupies 0.1⁻⁵⁰% by weight of the reactive additive.

The elastic polymer electrolyte shell may be in a form of a mixture, copolymer, semi-interpenetrating network, or simultaneous interpenetrating network with a second polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene (PVDF-HFP), cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof. This second polymer may be pre-mixed into the polymerizable monomer/oligomer. Alternatively, this second polymer may be dissolved in the liquid solvent where appropriate to form a solution prior to being combined with the ISE particles.

The present disclosure also provides a rechargeable lithium cell that comprises an anode, a cathode, and a separator disposed between the anode and the cathode. Preferably, the separator comprises a membrane produced from multiple hybrid solid electrolyte particulates that are consolidated together (e.g., via compression molding, extrusion, etc. for a thermoplastic elastomer or via a rubber processing procedure for a thermosetting or cross-linkable elastomer).

The present disclosure further provides a rechargeable lithium battery, including a lithium metal secondary cell, a lithium-ion cell, a lithium-sulfur cell, a lithium-ion sulfur cell, a lithium-selenium cell, or a lithium-air cell. This battery features a non-flammable, safe, and high-performing electrolyte as herein disclosed.

The hybrid solid electrolyte particulates may be mixed with an electrode active material (e.g., cathode active material particles, such as NCM, NCA and lithium iron phosphate) and a conducting additive (e.g., carbon black, carbon nanotubes, expanded graphite flakes, or graphene sheets) in a liquid medium to form a slurry or paste. The slurry or paste is then made (e.g., using casting or coating) into a desired electrode shape (e.g., cathode electrode), possibly supported on a surface of a current collector (e.g., an Al foil as a cathode current collector). An anode of a lithium-ion cell may be made in a similar manner using an anode active material (e.g., particles of graphite, Si, SiO, etc.). The anode electrode, a cathode electrode, and a separator are then combined to form a battery cell.

Still another preferred embodiment of the present disclosure is a rechargeable lithium-sulfur cell or lithium-ion sulfur cell containing a sulfur cathode having sulfur or lithium polysulfide as a cathode active material.

For a lithium metal cell (where lithium metal is the primary active anode material), the anode current collector may comprise a foil, perforated sheet, or foam of a metal having two primary surfaces wherein at least one primary surface is coated with or protected by a layer of lithiophilic metal (a metal capable of forming a metal-Li solid solution or is wettable by lithium ions), a layer of graphene material, or both. The metal foil, perforated sheet, or foam is preferably selected from Cu, Ni, stainless steel, Al, graphene-coated metal, graphite-coated metal, carbon-coated metal, or a combination thereof. The lithiophilic metal is preferably selected from Au, Ag, Mg, Zn, Ti, K, Al, Fe, Mn, Co, Ni, Sn, V, Cr, an alloy thereof, or a combination thereof.

For a lithium ion battery featuring the presently disclosed electrolyte, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCO₂O₄; (f) carbon or graphite particles (g) prelithiated versions thereof; and (h) combinations thereof.

In some embodiments, the anode active material contains a prelithiated Si, prelithiated Ge, prelithiated Sn, prelithiated SnOₓ, prelithiated SiOₓ, prelithiated iron oxide, prelithiated V₂O₅, prelithiated V₃O₈, prelithiated CO₃O₄, prelithiated Ni₃O₄, or a combination thereof, wherein x=1 to 2.

The rechargeable lithium cell may further comprise a cathode current collector selected from aluminum foil, carbon- or graphene-coated aluminum foil, stainless steel foil or web, carbon- or graphene-coated steel foil or web, carbon or graphite paper, carbon or graphite fiber fabric, flexible graphite foil, graphene paper or film, or a combination thereof. A web means a screen-like structure or a metal foam, preferably having interconnected pores or through-thickness apertures.

The present disclosure also provides a powder product comprising multiple hybrid solid electrolyte particulates as defined above. Each hybrid solid electrolyte particulate comprises one or a plurality of the inorganic solid electrolyte (ISE) particles encapsulated by an elastic polymer. For claim definition purposes, this elastic polymer can refer to a fully polymerized and/or fully crosslinked elastic polymer. This elastic polymer can also refer to a precursor to such a polymer, including, for instance, an oligomer, a growing polymer (not yet fully polymerized), or a crosslinkable polymer (not yet fully crosslinked). Such a live or reactive powder product makes it convenient for a battery cell producer to more readily form and consolidate an anode, a cathode, or a solid electrolyte separator at its own facility according to its own schedule.

Also provided is an anode comprising a mixture of multiple anode active material particles and multiple hybrid solid electrolyte particulates as defined above. In this anode, the multiple hybrid solid electrolyte particulates may each comprise one or a plurality of particles of the inorganic solid electrolyte encapsulated by a 1^{st} elastic polymer electrolyte and wherein the anode comprises multiple anode particulates each comprising one or a plurality of the anode active material particles encapsulated by a 2^{nd} elastic polymer electrolyte, wherein the 1^{st} elastic polymer electrolyte and the 2^{nd} elastic polymer electrolyte may be identical or different in chemical composition or structure.

The disclosure also provides a cathode comprising a mixture of multiple cathode active material particles and multiple hybrid solid electrolyte particulates as defined above. In this cathode, the multiple hybrid solid electrolyte particulates may each comprise one or a plurality of particles of an inorganic solid electrolyte encapsulated by a 1^{st} elastic polymer electrolyte and wherein the cathode comprises multiple cathode particulates each comprising one or a plurality of the cathode active material particles encapsulated by a 2^{nd} elastic polymer electrolyte, wherein the 1^{st} elastic polymer electrolyte and the 2^{nd} elastic polymer electrolyte are identical or different in chemical composition or structure.

The present disclosure also provides a process for producing a plurality of the hybrid solid electrolyte particulates as discussed or defined above, the process comprising: (A) dispersing a plurality of primary particles of an inorganic solid electrolyte, having a diameter or thickness from 1 nm to 20 m, in a reactive liquid mixture of (i) a monomer, oligomer, or cross-linkable polymer (as a precursor to the elastic polymer electrolyte) and (ii) an initiator and/or a cross-linking agent to form a reactive slurry; (B) forming the reactive slurry into micro-droplets; and (C) polymerizing and/or curing the monomer, the oligomer or the cross-linkable polymer in said micro-droplets to form the hybrid solid electrolyte particulates.

There is no particular restriction on the micro-droplet forming procedure. Preferably, step (B) of forming micro-droplets comprises a procedure selected from pan-coating, air-suspension coating, centrifugal extrusion, vibration-nozzle encapsulation, spray-drying, kneadering, casting and drying, coacervation-phase separation, interfacial polycondensation or interfacial cross-linking, in-situ polymerization, matrix polymerization, extrusion and palletization, or a combination thereof. The micro-droplets contain water or a liquid solvent and the process further comprises a step of removing the water or solvent.

The process may further comprise a step of combining the hybrid solid electrolyte particulates, particles of an anode active material, and a conductive additive into an anode electrode; or a step of combining the hybrid solid electrolyte particulates, particles of a cathode active material, and a conductive additive into a cathode electrode.

The process may further comprise a step of combining and consolidating the hybrid solid electrolyte particulates to form an elastic solid electrolyte separator.

The disclosure also provides a process for producing a plurality of the hybrid solid electrolyte particulates as defined earlier, the process comprising: (a) dispersing a plurality of primary particles of an inorganic solid electrolyte, having a diameter or thickness from 1 nm to m, in a liquid solution, comprising an elastic polymer (e.g., a thermoplastic elastomer) dissolved in a liquid solvent, to form a slurry; (b) forming the slurry into micro-droplets; and (c) removing the liquid solvent in said micro-droplets to form the hybrid solid electrolyte particulates. The micro-droplet forming procedure may be selected from pan-coating, air-suspension coating, centrifugal extrusion, vibration-nozzle encapsulation, spray-drying, extrusion and palletization, kneadering, or a combination thereof.

The process may further comprise a step of combining and consolidating multiple hybrid solid electrolyte particulates to form a solid electrolyte separator (e.g., via compressing molding).

Regardless how the hybrid solid electrolyte particulate are made, the process may further comprise a step of combining and consolidating (i) the hybrid solid electrolyte particulates having a 1^{st} solid electrolyte polymer encapsulating inorganic solid electrolyte particles and (ii) anode or cathode active material particles encapsulated by a 2^{nd} solid electrolyte polymer, along with an optional conductive additive, to form an anode or cathode electrode, wherein the 1^{st} solid electrolyte polymer and the 2^{nd} solid electrolyte polymer are identical or different in chemical composition or structure.

These and other advantages and features of the present invention will become more transparent with the description of the following best mode practice and illustrative examples.

### BRIEF DESCRIPTION OF THE DRAWINGS

FIG. 1(A) Schematic of hybrid solid electrolyte particulates according to certain embodiments of the present disclosure;

FIG. 1(B) A process flow chart to illustrate a process for producing a plurality of hybrid solid electrolyte particulates according to some embodiments of the present disclosure;

FIG. 1(C) Another process flow chart to illustrate a process for producing a plurality of hybrid solid electrolyte particulates according to some embodiments of the present disclosure.

FIG. 1(D) A chart to illustrate a process for producing an electrode (anode or cathode) by mixing and consolidating a plurality of hybrid solid electrolyte particulates (containing a 1^{st} elastic solid polymer electrolyte encapsulating ISE particles) and a plurality of particulates each comprising one or more than one active material particles encapsulated by a 2^{nd} solid electrolyte polymer, according to some embodiments of the present disclosure.

FIG. 2(A) Structure of an anode-less lithium metal cell (as manufactured or in a discharged state) according to some embodiments of the present disclosure;

FIG. 2(B) Structure of an anode-less lithium metal cell (in a charged state) according to some embodiments of the present disclosure.

### DETAILED DESCRIPTION

The present disclosure provides hybrid solid electrolyte particulates for use as a solid electrolyte for a safe and high-performing lithium battery, which can be any of various types of lithium-ion cells or lithium metal cells. A high degree of safety is imparted to this battery by a novel and unique electrolyte that is highly flame-resistant and would not initiate a fire or sustain a fire and, hence, would not pose explosion danger. This disclosure has solved the very most critical issue that has plagued the lithium-metal and lithium-ion industries for more than two decades.

As indicated earlier in the Background section, a strong need exists for a safe, non-flammable, yet process-friendly solid-state electrolyte system for a rechargeable lithium cell that is compatible with existing battery production facilities. It is well-known in the art that the conventional solid-state electrolyte batteries typically cannot be produced using existing lithium-ion battery production equipment or processes.

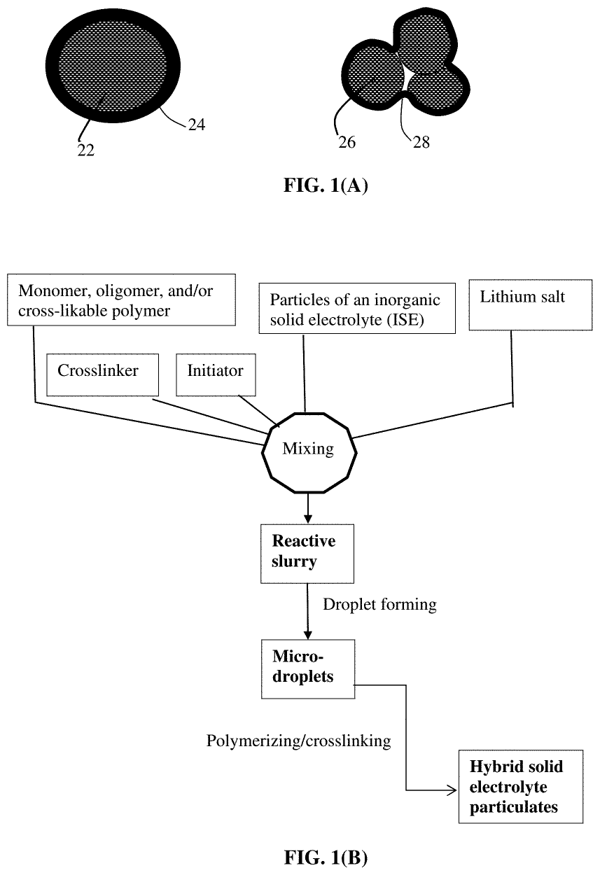

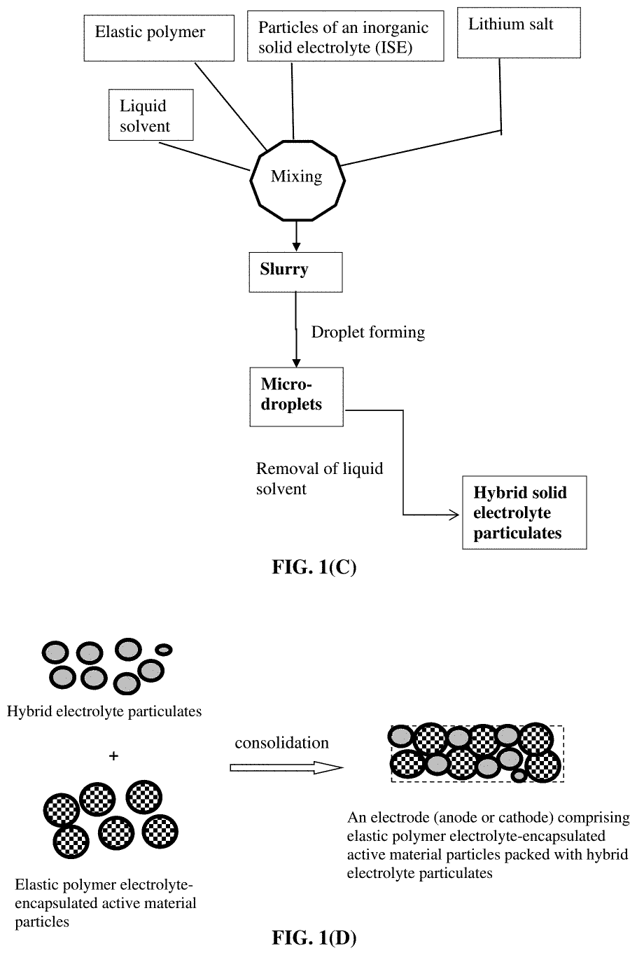

As illustrated in FIG. 1(A), the disclosed hybrid solid electrolyte particulate comprises one particle (e.g., 22) or a plurality of particles (e.g., 26) of an inorganic solid electrolyte (ISE) encapsulated by a shell of an elastic polymer electrolyte (e.g., 24, 28). This particulate or secondary particle has three main features: (i) the hybrid solid electrolyte particulate has a lithium-ion conductivity from 10⁻⁶ S/cm to 5×10⁻² S/cm and both the inorganic solid electrolyte and the polymer electrolyte individually have a lithium-ion conductivity no less than 10⁻⁶ S/cm; (ii) the polymer electrolyte-to inorganic solid electrolyte ratio is from 1/100 to 100/1 or the polymer electrolyte shell has a thickness from 1 nm to 10 μm; and (iii) the elastic polymer electrolyte has a recoverable elastic tensile strain from 5% to 1,000%. The encapsulating polymer shell preferably has a thickness from 2 nm to 2 μm, more preferably less than 1 μm, and most preferably less than 500 nm. In certain embodiments, the inorganic solid electrolyte material particles are preferably from 5 nm to 20 μm in diameter, more preferably from 20 nm to 10 μm, and most preferably smaller than 5 μm).

Also provided is a lithium-ion or lithium metal cell containing multiple hybrid solid electrolyte particulates in the anode, cathode and/or the separator.

Preferably, the hybrid electrolyte particle has a lithium-ion conductivity from 10⁻⁵ S/cm to 5×10⁻² S/cm. Preferably, the elastic polymer electrolyte alone (without the ISE) has a lithium-ion conductivity from 10⁻⁸ S/cm to 5×10⁻² S/cm, more typically from 10⁻⁶ S/cm to 10⁻² S/cm, more preferably greater than 10⁻⁵ S/cm, furthermore preferably greater than 10⁻⁴ S/cm, and most preferably greater than 10⁻³ S/cm.

The elastic polymer electrolyte should have a high elasticity (high elastic tensile deformation value). An elastic deformation is a deformation that is fully recoverable and the recovery process is essentially instantaneous (no significant time delay). An elastomer, such as a vulcanized natural rubber, can exhibit an elastic deformation from 5% up to 1,000% (10 times of its original length), more typically from 10% to 800%, and furthermore typically from 50% to 500%, and most typically and desirably from 100% to 500%. It may be noted that although a metal typically has a high ductility (i.e., can be extended to a large extent without breakage), the majority of the deformation is plastic deformation (non-recoverable) and only a small amount of elastic deformation (typically <1% and more typically <0.2%).

In certain embodiments, the elastic polymer electrolyte comprises a material selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyphosphazene, polyurethane, urethane-urea copolymer, a copolymer thereof, a sulfonated version thereof, or a combination thereof.

A broad array of elastomers, as a neat resin alone or as a matrix material for an elastomeric matrix composite, can be used to encapsulate an anode active material particle or multiple particles. Encapsulation means substantially fully embracing the particle(s) without allowing the particle to be in direct contact with electrolyte in the battery. The elastomeric material may be selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

The urethane-urea copolymer film usually consists of two types of domains, soft domains and hard ones. Entangled linear backbone chains consisting of poly(tetramethylene ether) glycol (PTMEG) units constitute the soft domains, while repeated methylene diphenyl diisocyanate (MDI) and ethylene diamine (EDA) units constitute the hard domains. The lithium ion-conducting additive can be incorporated in the soft domains or other more amorphous zones.

In some embodiments, the elastomeric material is an elastomer matrix composite containing a lithium ion-conducting additive dispersed in an elastomer matrix material, wherein said lithium ion-conducting additive is selected from Li₂CO₃, Li₂O, Li₂C₂O₄, LiGH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

In some embodiments, the elastomeric material is an elastomer matrix composite containing a lithium ion-conducting additive dispersed in an elastomer matrix material, wherein said lithium ion-conducting additive contains a lithium salt selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

The elastic polymer electrolyte may further comprise a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, poly(alkylsiloxane), poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyacrylamide, a polyionic liquid, polymerized 1,3-dioxolane, polyepoxide ether, polysiloxane, poly(dimethyl siloxane), poly(alkyl siloxane), poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a crosslinked polymer containing chains of ethylene glycol phenyl ether acrylate) (PEGPEA) or ethoxylated trimethyl propyl triacrylate (ETPTA), poly(phosphate), poly(phosphonate), poly(phosphinate), poly(phosphine), poly(phosphine oxide), poly(phosphonic acid), poly(phosphorous acid), poly(phosphite), poly(phosphoric acid), poly(phosphazene), a chemical derivative thereof, a copolymer thereof, a sulfonated derivative thereof, or a combination thereof, wherein the ion-conducting polymer and the elastic polymer form a polymer blend, a copolymer, a crosslinked network of chains, a semi-interpenetrating network, or a simultaneous interpenetrating network.

The inorganic solid electrolyte material may be selected from an oxide type, sulfide type (including, but not limited to, the thio-LISICON type, glass-type, glass ceramic-type, and argyrodite-type sulfide electrolyte), hydride type, halide type, borate type, phosphate type, lithium phosphorus oxynitride (LiPON), garnet-type, lithium superionic conductor (LISICON) type, sodium superionic conductor (NASICON) type, or a combination thereof.

The inorganic solid electrolyte particles that can be incorporated into the hybrid electrolyte include, but are not limited to, perovskite-type, NASICON-type, garnet-type and sulfide-type materials. A representative perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in a polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid-state electrolyte for the lithium-ion battery. The ionic conductivity of LiZr₂(PO₄)₃ is very low, but can be improved by the substitution of Hf or Sn. This can be further enhanced with substitution to form Li₁₊ₓMₓTi₂₋ₓ(PO₄)₃ (M=Al, Cr, Ga, Fe, Sc, In, Lu, Y or La). Al substitution has been demonstrated to be the most effective solid-state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M=W or Te), a broad series of garnet-type materials may be used as an additive, including LisLa₃M₂O₂ (M=Nb or Ta), Li₆ALa₂M₂O₁₂ (A=Ca, Sr or Ba; M=Nb or Ta), Li_{5.5}La₃M_{1.75}B_{0.25}O₁₂ (M=Nb or Ta; B=In or Zr) and the cubic systems Li₇La₃Zr₂O₁₂ and Li_{7.06}M₃Y_{0.06}Zr_{1.94}O₁₂ (M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The conductivity in this type of material is 6.9×10⁻⁴ S/cm, which was achieved by doping the Li₂S—SiS₂ system with Li₃PO₄. Other sulfide-type solid-state electrolytes can reach a good lithium-ion conductivity close to 10⁻² S/cm. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer as herein disclosed.

These inorganic solid electrolyte (ISE) particles encapsulated by an elastic electrolyte polymer shell can help enhance the lithium ion conductivity of certain polymers that have a lower ion conductivity than the encapsulated SEL. Preferably and typically, the elastic polymer electrolyte has a lithium ion conductivity no less than 10⁻⁵ S/cm, more desirably no less than 10⁻⁴ S/cm, further preferably no less than 10⁻³ S/cm, and most preferably no less than 10⁻² S/cm.

It should be noted that certain inorganic solid electrolytes (e.g., sulfide type ISE) can have a higher lithium-ion conductivity as compared to certain selected polymers. However, sulfide type ISEs are air-sensitive and air-sensitive and, hence, cannot be combined with an anode active material (e.g., graphite or Si) to form an anode using water as a liquid medium in a commonly used slurry coating process. Furthermore, sulfide-type ISEs have a very narrow electrochemical stability window (e.g., from 1.8-2.5 V relative to Li/Li⁺), making them unsuitable for use in the anode, where lithium ion intercalation occurs at approximately 0.23 V for graphite and 0.5 V for Si (significantly lower than 1.8 V). They are also unsuitable for the cathode since the cathode active material typically operates at 3.2-4.4 V for lithium iron phosphate and all lithium transition metal oxides. We have solved this problem by encapsulating the ISE particles with a polymer electrolyte that typically has a significantly wider electrochemical stability window (e.g., can be from 0 to 4.5 V relative to Li/Li⁺). The polymer protection also enables the ISEs processible using the current lithium-ion cell production processes.

The intended elastic polymer (the elastic polymer precursor) typically is initially in a monomer, oligomer, partially polymerized, or partially crosslinked state having a lithium salt dissolved therein. The precursor is then combined with ISE particles to form micro-droplets that are composed of ISE particles encapsulated by the polymer precursor. This is followed by further or fully polymerizing or crosslinking the precursor to form a shell that embraces and encapsulates single or multiple inorganic solid electrolyte (ISE) particles.

The hybrid solid electrolyte particulates (secondary particles) can then be utilized in the anode, the cathode, and/or the separator. Multiple hybrid solid electrolyte particulates may be formed (e.g., melt fusion followed by solidification of a thermoplastic elastomer) into an ion-conducting membrane as a separator, preferably having a thickness from 10 nm to less than 100 μm. Multiple hybrid particulates containing non-fully polymerized/crosslinked precursor may also be compacted and formed into a thin layer form (e.g., 10 nm-100 μm) and then subjected to completion of polymerization/crosslinking.

Multiple hybrid solid electrolyte particulates may also be mixed with a desired amount of an anode active material (e.g., graphite, Si, SiO particles, etc.) to form an anode (negative electrode) using a conventional electrode fabrication procedure (e.g., slurry coating process). Similarly, multiple hybrid solid electrolyte particulates may also be mixed with a desired amount of a cathode active material (e.g., lithium iron phosphate and lithium metal oxide particles) to form a cathode (positive electrode) using a conventional electrode fabrication procedure (e.g., slurry coating process). This strategy enables us to achieve several desirable attributes of the resultant hybrid electrolyte, electrodes, separator, and cell, as discussed in the Summary section.

The elastic nature of the elastic polymer shell in the hybrid solid electrolyte particulates facilitate excellent and reversible contacts between the electrolyte and an electrode active material phase (hence, significantly reduced interfacial impedance) and the formation of a contiguous network of lithium ion-conducting pathways.

The cathode may contain a cathode active material (along with an optional conductive additive and an optional resin binder) and an optional cathode current collector (such as Al foil) supporting the cathode active material. The anode may have an anode current collector, with or without an anode active material in the beginning when the cell is made. It may be noted that if no conventional anode active material, such as graphite, Si, SiO, Sn, and conversion-type anode materials, and no lithium metal is present in the cell when the cell is made and before the cell begins to charge and discharge, the battery cell is commonly referred to as an “anode-less” lithium cell.

In certain embodiments, the elastomer may comprise a flame-resisting or flame-retardant ingredient selected from an organic phosphorus compound, an inorganic phosphorus compound, a halogenated derivative thereof, a polymerized version thereof, or a combination thereof. The organic phosphorus compound or the inorganic phosphorus compound preferably is selected from the group consisting of phosphates, phosphonates, phosphonic acids, phosphorous acids, phosphites, phosphoric acids, phosphinates, phosphines, phosphine oxides, phosphazene compounds, derivatives thereof, and combinations thereof.

In certain embodiments, the elastic polymer (elastomer) may comprise a polymer synthesized from a monomer selected from the group consisting of fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

As an example, polyphosphazenes, also commonly referred to as poly(organo) phosphazenes, are a family of inorganic molecular hybrid polymers based on a phosphorus-nitrogen backbone substituted with organic side groups which show very differing properties due to the vast array of organic substituents possible. The method of synthesizing polyphosphazenes depends on the desired type of polyphosphazene. The most widely used method for linear polymers is based on a two-step process. In the first step, hexachlorocyclotriphosphazene, (NPCl₂)₃ (Chemical formula 1) is heated in a sealed system at 250° C. to convert it to a long chain linear polymer, [NPCl₂]n (or Chemical formula 2), having typically 15,000 or more repeating units. This reaction is illustrated as follows:

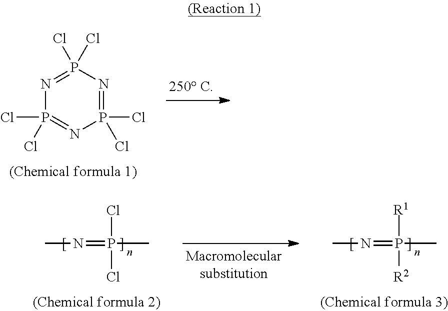

In the second step the chlorine atoms linked to phosphorus in the polymer are replaced by organic groups through reactions with R¹ or R² to form Chemical formula 3, where R¹ and R² may be independently selected from alkoxides, aryloxides, amines, or organometallic reagents, etc. Many different reagents can be used in this macromolecular substitution reaction and, hence, a large number of different polymers can be produced. All these polymers are herein referred to as a polyphosphazene. Some examples of the macromolecular substitution are shown below (Reactions 2a, 2b, and 2c):

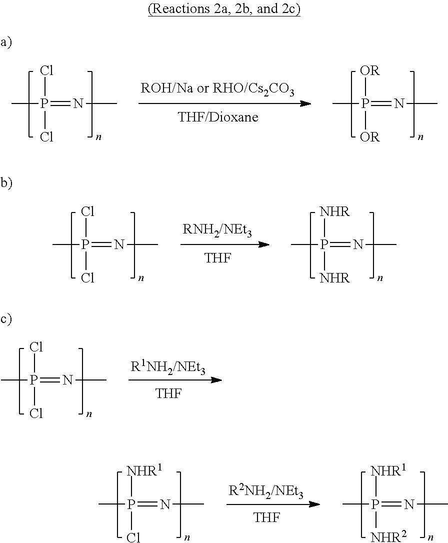

Polyphosphazene polymers include a wide range of hybrid inorganic-organic polymers with a number of different skeletal architectures that has the backbone P—N—P—N—P—N—. In nearly all of these materials two organic side groups are attached to each phosphorus center. Examples of phosphazene polymers include the following:

(a) Linear polymers have the formula (N=PR¹R¹)ₙ, where R¹ and R² are organic;
(b) Cyclolinear and cyclomatrix polymers in which small phosphazene rings are connected together by organic chain units.
(c) Block copolymer, star, dendritic, or comb-type structures.

More than 700 different polyphosphazenes are known, with different side groups (R) and different molecular architectures.

In certain embodiments, the polymer comprises a polyphosphazene selected from the groups consisting of (a) linear polymers having the formula (N=PR¹R²)ₙ, where R¹ and R² are organic; (b) cyclolinear and cyclomatrix polymers in which small phosphazene rings are connected together by organic chain units; (c) block copolymer, star, dendritic, or comb-type structures; and combinations thereof.

The phosphazene compound may be synthesized from a precursor monomer, oligomer, or reactive polymer selected from Chemical formula 1, Chemical formula 2, Chemical formula 3, Chemical formula 4, or a combination thereof:

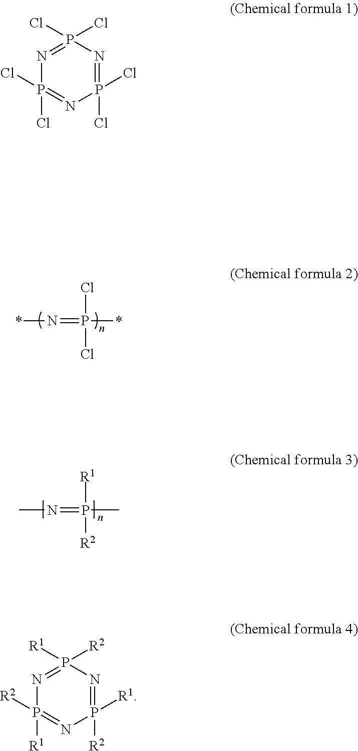

wherein R, R¹ and R² are independently selected from an organic group or an organometallic group.

It may be noted that a high-elasticity polymer may be referred to as an elastomer. Typically, a high-elasticity polymer has the characteristic that it has a low degree of cross-linking or has a long chain between two crosslinking points in the network of polymer chains. We have surprisingly discovered that phosphazene compounds or derivatives typically can self-crosslink or can be crosslinked with a crosslinking agent to a desired extent that affords a desired elasticity to the polymer.

Polyphosphazenes may be conveniently divided into two major classes-those in which the side groups are attached to phosphorus via oxygen (P—OR) or nitrogen (P—NR₂) linkages and those in which the substituents are attached directly to phosphorus through phosphorus-carbon bonds, i.e., the poly(alkyl phosphazenes and poly(aryl phosphazenes). The present disclosure provides both types of polyphosphazenes as an ingredient in the quasi-solid or solid electrolytes.

The elastic polymer electrolyte in the encapsulating shell may be in a form of a polymer blend, copolymer, semi-interpenetrating network, or simultaneous interpenetrating network with an ion-conducting polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

The inorganic solid electrolyte particles encapsulated by an electrolyte polymer can help enhance the lithium-ion conductivity of the resulting hybrid solid electrolyte particulates if the encapsulating polymer has an intrinsically low ion conductivity. Preferably and typically, the polymer has a lithium-ion conductivity no less than 10⁻⁵ S/cm, more preferably no less than 10⁻⁴ S/cm, and further preferably no less than 10⁻³ S/cm.

The disclosed lithium battery can be a lithium-ion battery or a lithium metal battery, the latter having lithium metal as the primary anode active material. The lithium metal battery can have lithium metal implemented at the anode when the cell is made. Alternatively, the lithium may be stored in the cathode active material and the anode side is lithium metal-free initially. This is called an anode-less lithium metal battery.

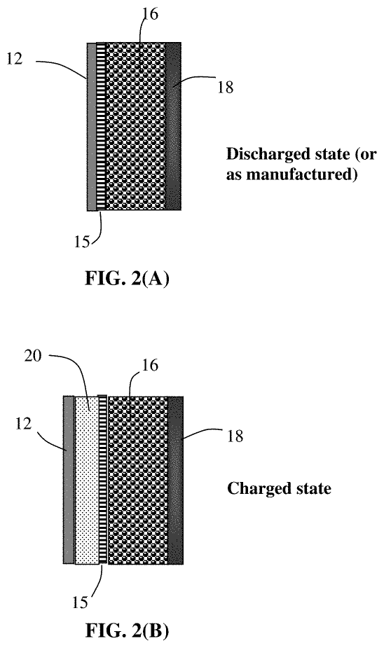

As illustrated in FIG. 2(A), the anode-less lithium cell is in an as-manufactured or fully discharged state according to certain embodiments of the present disclosure. The cell comprises an anode current collector 12 (e.g., Cu foil), a separator, a cathode layer 16 comprising a cathode active material, an optional conductive additive (not shown), an optional resin binder (not shown), and a plurality of the presently disclosed hybrid solid electrolyte particulates (dispersed in the entire cathode layer and in contact with the cathode active material), and a cathode current collector 18 that supports the cathode layer 16. There is no lithium metal in the anode side when the cell is manufactured. The separator can be a polymeric membrane, solid-state electrolyte, or preferably a separator made from consolidation of multiple hybrid solid electrolyte particulates herein provided.

In a charged state, as illustrated in FIG. 2(B), the cell comprises an anode current collector 12, lithium metal 20 plated on a surface (or two surfaces) of the anode current collector 12 (e.g., Cu foil), a separator 15, a cathode layer 16, and a cathode current collector 18 supporting the cathode layer. The lithium metal comes from the cathode active material (e.g., LiCoO₂ and LiMn₂O₄) that contains Li element when the cathode is made. During a charging step, lithium ions are released from the cathode active material and move to the anode side to deposit onto a surface or both surfaces of an anode current collector.

One unique feature of the presently disclosed anode-less lithium cell is the notion that there is substantially no anode active material and no lithium metal is present when the battery cell is made. The commonly used anode active material, such as an intercalation type anode material (e.g., graphite, carbon particles, Si, SiO, Sn, SnO₂, Ge, etc.), P, or any conversion-type anode material, is not included in the cell. The anode only contains a current collector or a protected current collector. No lithium metal (e.g., Li particle, surface-stabilized Li particle, Li foil, Li chip, etc.) is present in the anode when the cell is made; lithium is basically stored in the cathode (e.g., Li element in LiCoO₂, LiMn₂O₄, lithium iron phosphate, lithium polysulfides, lithium polyselenides, etc.). During the first charge procedure after the cell is sealed in a housing (e.g., a stainless steel hollow cylinder or an Al/plastic laminated envelop), lithium ions are released from these Li-containing compounds (cathode active materials) in the cathode, travel through the electrolyte/separator into the anode side, and get deposited on the surfaces of an anode current collector. During a subsequent discharge procedure, lithium ions leave these surfaces and travel back to the cathode, intercalating or inserting into the cathode active material.

Such an anode-less cell is much simpler and more cost-effective to produce since there is no need to have a layer of anode active material (e.g., graphite particles, along with a conductive additive and a binder) pre-coated on the Cu foil surfaces via the conventional slurry coating and drying procedures. The anode materials and anode active layer manufacturing costs can be saved. Furthermore, since there is no anode active material layer (otherwise typically 40⁻²⁰⁰ μm thick), the weight and volume of the cell can be significantly reduced, thereby increasing the gravimetric and volumetric energy density of the cell.

Another important advantage of the anode-less cell is the notion that there is no lithium metal in the anode when a lithium metal cell is made. Lithium metal (e.g., Li metal foil and particles) is highly sensitive to air moisture and oxygen and notoriously known for its difficulty and danger to handle during manufacturing of a Li metal cell. The manufacturing facilities should be equipped with special class of dry rooms, which are expensive and significantly increase the battery cell costs.

The anode current collector may be selected from a foil, perforated sheet, or foam of Cu, Ni, stainless steel, Al, graphene, graphite, graphene-coated metal, graphite-coated metal, carbon-coated metal, or a combination thereof. Preferably, the current collector is a Cu foil, Ni foil, stainless steel foil, graphene-coated Al foil, graphite-coated Al foil, or carbon-coated Al foil.

The anode current collector typically has two primary surfaces. Preferably, one or both of these primary surfaces is deposited with multiple particles or coating of a lithium-attracting metal (lithiophilic metal), wherein the lithium-attracting metal, preferably having a diameter or thickness from 1 nm to 10 m, is selected from Au, Ag, Mg, Zn, Ti, K, Al, Fe, Mn, Co, Ni, Sn, V, Cr, an alloy thereof, or a combination thereof. This deposited metal layer may be further deposited with a layer of graphene that covers and protects the multiple particles or coating of the lithiophilic metal.

The graphene layer may comprise graphene sheets selected from single-layer or few-layer graphene, wherein the few-layer graphene sheets are commonly defined to have 2⁻¹⁰ layers of stacked graphene planes having an inter-plane spacing d₀₀₂ from 0.3354 nm to 0.6 nm as measured by X-ray diffraction. The single-layer or few-layer graphene sheets may contain a pristine graphene material having essentially zero % of non-carbon elements, or a non-pristine graphene material having 0.001% to 45% by weight of non-carbon elements. The non-pristine graphene may be selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

The graphene layer may comprise graphene balls and/or graphene foam. Preferably, the graphene layer has a thickness from 1 nm to 50 μm and/or has a specific surface area from 5 to 1000 m²/g (more preferably from 10 to 500 m²/g).

For a lithium-ion battery featuring the presently disclosed electrolyte, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCO₂O₄; (f) carbon or graphite particles (g) prelithiated versions thereof; and (h) combinations thereof.

In addition to the non-flammability and high lithium ion transference numbers, there are several additional benefits associated with using the presently disclosed solid-state electrolytes. As one example, these electrolytes can significantly enhance cycling and safety performance of rechargeable lithium batteries through effective suppression of lithium dendrite growth. Due to a good contact between the electrolyte and an electrode, the interfacial impedance can be significantly reduced.

As another benefit example, this electrolyte is capable of inhibiting lithium polysulfide dissolution at the cathode and migration to the anode of a Li—S cell, thus overcoming the polysulfide shuttle phenomenon and allowing the cell capacity not to decay significantly with time. Consequently, a coulombic efficiency nearing 100% along with long cycle life can be achieved.

There is also no restriction on the type of the cathode materials that can be used in practicing the present disclosure. For Li—S cells, the cathode active material may contain lithium polysulfide or sulfur. If the cathode active material includes lithium-containing species (e.g., lithium polysulfide) when the cell is made, there is no need to have a lithium metal pre-implemented in the anode.

There are no particular restrictions on the types of cathode active materials that can be used in the presently disclosed lithium battery, which can be a primary battery or a secondary battery. The rechargeable lithium metal or lithium-ion cell may preferably contain a cathode active material selected from, as examples, a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

In a rechargeable lithium cell, the cathode active material may be selected from a metal oxide, a metal oxide-free inorganic material, an organic material, a polymeric material, sulfur, lithium polysulfide, selenium, or a combination thereof. The metal oxide-free inorganic material may be selected from a transition metal fluoride, a transition metal chloride, a transition metal dichalcogenide, a transition metal trichalcogenide, or a combination thereof. In a particularly useful embodiment, the cathode active material is selected from FeF₃, FeCl₃, CuCl₂, TiS₂, TaS₂, MoS₂, NbSe₃, MnO₂, CoO₂, an iron oxide, a vanadium oxide, or a combination thereof, if the anode contains lithium metal as the anode active material. The vanadium oxide may be preferably selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5. For those cathode active materials containing no Li element therein, there should be a lithium source implemented in the cathode side to begin with. This can be any compound that contains a high lithium content, or a lithium metal alloy, etc.

In a rechargeable lithium cell (e.g., the lithium-ion battery cell), the cathode active material may be selected to contain a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

Particularly desirable cathode active materials comprise lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

In a preferred lithium metal secondary cell, the cathode active material preferably contains an inorganic material selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof. Again, for those cathode active materials containing no Li element therein, there should be a lithium source implemented in the cathode side to begin with.

In another preferred rechargeable lithium cell (e.g. a lithium metal secondary cell or a lithium-ion cell), the cathode active material contains an organic material or polymeric material selected from Poly(anthraquinonyl sulfide) (PAQS), lithium oxocarbons (including squarate, croconate, and rhodizonate lithium salts), oxacarbon (including quinines, acid anhydride, and nitrocompound), 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material (redox-active structures based on multiple adjacent carbonyl groups (e.g., “C₆O₆”-type structure, oxocarbons), Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS2)₃]n), lithiated 1,4,5,8-naphthalenetetraol formaldehyde polymer, Hexaazatrinaphtylene (HATN), Hexaazatriphenylene hexacarbonitrile (HAT(CN)6), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

The thioether polymer may be selected from Poly[methanetetryl-tetra(thiomethylene)](PMTTM), Poly(2,4-dithiopentanylene) (PDTP), or Poly(ethene-1,1,2,2-tetrathiol) (PETT) as a main-chain thioether polymer, in which sulfur atoms link carbon atoms to form a polymeric backbones. The side-chain thioether polymers have polymeric main-chains that consist of conjugating aromatic moieties, but having thioether side chains as pendants. Among them Poly(2-phenyl-1,3-dithiolane) (PPDT), Poly(1,4-di(1,3-dithiolan-2-yl)benzene) (PDDTB), poly(tetrahydrobenzodithiophene) (PTHBDT), and poly[1,2,4,5-tetrakis(propylthio)benzene](PTKPTB) have a polyphenylene main chain, linking thiolane on benzene moieties as pendants. Similarly, poly[3,4(ethylenedithio)thiophene] (PEDTT) has polythiophene backbone, linking cyclo-thiolane on the 3,4-position of the thiophene ring.

In yet another preferred rechargeable lithium cell, the cathode active material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof. This class of lithium secondary batteries has a high capacity and high energy density. Again, for those cathode active materials containing no Li element therein, there should be a lithium source implemented in the cathode side to begin with.

The processes that can be used to produce the hybrid solid electrolyte particulates are herein further discussed. For convenience, we will divide the elastic polymers into two types. The first type contains those polymers that have been fully polymerized and not cross-linkable (e.g., linear-chain or branched polymers that can be dissolved in a liquid solvent). The second type contains those materials that remain in the monomer state (e.g., monomer+initiator+optional curing agent), oligomer state (live short chains that are capable of growing and/or cross-linking), or cross-linkable polymer (e.g., having at least 3 functional groups for reacting with other chains or curing agents).

As illustrated in FIG. 1(C), for those first-type polymers that are soluble in a liquid solvent one can begin by dissolving a polymer (optionally but preferably, along with a desired amount of a lithium salt) to form a polymer/solvent liquid solution. A desired amount of fine particles (e.g., 5 nm to 10 μm in diameter) of an inorganic solid electrolyte (ISE) are then dispersed into the liquid solution to form a slurry. The slurry may then be formed into hybrid particulates (polymer electrolyte-encapsulated ISE secondary particles) using any known particle-forming procedure combined with solvent removal (e.g., spray-drying).

In some other examples based on the second-type polymers (illustrated in FIG. 1(B)), the polymer electrolyte as the encapsulating shell in the hybrid solid electrolyte particulate comprises a polymer that is a polymerization or crosslinking product of a reactive additive comprising (i) a first liquid solvent that is polymerizable and/or cross-linkable, (ii) an initiator and/or curing agent, and (iii) a lithium salt (optional but desirable), wherein the first liquid solvent occupies from 1% to 99% by weight based on the total weight of the reactive additive.

In these examples, a desired amount of fine particles of an inorganic solid electrolyte may be dispersed in the reactive additive to form a reactive slurry. The slurry may then be formed into secondary particles having ISE particles being embraced with a thin layer of reactive additive. This is followed by polymerization and/or crosslinking to form the hybrid solid electrolyte particulates, wherein each particulate comprises one or more than one primary particles of an ISE being encapsulated by a substantially solid polymer electrolyte. Preferably, at least 30% by weight of the polymerizable precursor is polymerized; more preferably >50%, further preferably >70%, and most preferably >99% is polymerized.

Shown in FIG. 1(D) is a schematic to illustrate a process for producing an electrode (anode or cathode) by mixing and consolidating (i) a plurality of hybrid solid electrolyte particulates each containing a 1^{st} elastic solid polymer electrolyte encapsulating ISE particles; (ii) a plurality of particulates each comprising one or more than one active (anode or cathode) material particles encapsulated by a 2^{nd} solid electrolyte polymer (preferably also elastic); and optionally (iii) conducting additive. The 1^{st} elastic electrolyte polymer may be identical to or different than the 2^{nd} electrolyte polymer. These hybrid solid electrolyte particulates and the active material particulates are preferably packed together in such a manner that the polymers in the shell form a contiguous phase capable of transporting lithium ions. Further preferably, the 1^{st} and the 2^{nd} electrolyte polymers are fused or consolidated together.

Several micro-encapsulation processes require the polymer to be dissolvable in a solvent or its precursor (e.g., monomer or oligomer) initially contains a liquid state (flowable). Fortunately, all the polymers or their precursors used herein are soluble in some common solvents or the monomer or other polymerizing/curing ingredients are in a liquid state to begin with.

Some elastomers are originally in an unsaturated chemical state (unsaturated rubbers) that can be cured by sulfur vulcanization to form a cross-linked polymer that is highly elastic (hence, an elastomer). Prior to vulcanization, these polymers or oligomers are soluble in an organic solvent to form a polymer solution. Particles of an anode active material (e.g., SnO₂ nano particles and Si nano-wires) can be dispersed in this polymer solution to form a suspension (dispersion or slurry) of an active material particle-polymer mixture. This suspension can then be subjected to a solvent removal treatment while individual particles remain substantially separated from one another. The polymer precipitates out to deposit on surfaces of these active material particles. This can be accomplished, for instance, via spray drying.

Hybrid solid electrolyte particulates may be produced in a similar manner by replacing those active material particles with particles of an ISE. Encapsulated cathode active materials may also be produced in a similar manner.

Unsaturated rubbers that can be vulcanized to become elastomer include natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), Some elastomers are saturated rubbers that cannot be cured by sulfur vulcanization; they are made into a rubbery or elastomeric material via different means: e.g., by having a copolymer domain that holds other linear chains together. Each of these elastomers can be used to encapsulate particles of an anode active material by one of several means: melt mixing (followed by pelletizing and ball-milling, for instance), solution mixing (dissolving the anode active material particles in an uncured polymer, monomer, or oligomer, with or without an organic solvent) followed by drying (e.g. spray drying), interfacial polymerization, or in situ polymerization of elastomer in the presence of anode active material particles.

Saturated rubbers and related elastomers in this category include EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, and protein elastin. Polyurethane and its copolymers (e.g. urea-urethane copolymer) are particularly useful elastomeric shell materials for encapsulating anode active material particles.

There are three broad categories of micro-encapsulation methods that can be implemented to produce electrolyte polymer-embedded or encapsulated anode particles (the micro-droplets): physical methods, physico-chemical methods, and chemical methods. The physical methods include pan-coating, air-suspension coating, centrifugal extrusion, vibration nozzle, and spray-drying methods. The physico-chemical methods include ionotropic gelation and coacervation-phase separation methods. The chemical methods include interfacial polycondensation, interfacial cross-linking, in-situ polymerization, and matrix polymerization. In all of these methods, polymerization and/or crosslinking may be allowed to proceed during and/or after the micro-droplet formation procedure.

Pan-coating method: The pan coating process involves tumbling the primary particles of an inorganic solid electrolyte (ISE) in a pan or a similar device while the matrix material (e.g., monomer/oligomer liquid or uncured polymer/solvent solution; possibly containing a lithium salt dispersed or dissolved therein) is applied slowly until a desired amount of particulates is attained.

Air-suspension coating method: In the air suspension coating process, the solid primary particles of an ISE are dispersed into the supporting air stream in an encapsulating chamber. A controlled stream of a reactive precursor solution (e.g., polymer or its monomer or oligomer dissolved in a solvent; or its monomer or oligomer alone in a liquid state) is concurrently introduced into this chamber, allowing the solution to hit and coat/embed the suspended particles. These suspended particles are encapsulated by or embedded in the reactive precursor (monomer, oligomer, etc. which is polymerized/cured concurrently or subsequently) while the volatile solvent is removed, leaving behind a hybrid particulate. This process may be repeated several times until the required parameters, such as full-encapsulation, are achieved. The air stream which supports the ISE particles also helps to dry them, and the rate of drying is directly proportional to the temperature of the air stream, which can be adjusted for an optimized polymer amount.

In a preferred mode, the ISE particles in the encapsulating zone portion may be subjected to re-circulation for repeated coating. Preferably, the encapsulating chamber is arranged such that the particles pass upwards through the encapsulating zone, then are dispersed into slower moving air and sink back to the base of the encapsulating chamber, enabling repeated passes of the particles through the encapsulating zone until the desired encapsulating polymer or precursor amount is achieved.

Centrifugal extrusion: Primary anode particles may be embedded in a polymer network or precursor material using a rotating extrusion head containing concentric nozzles. In this process, a stream of core fluid (slurry containing anode particles dispersed in a solvent) is surrounded by a sheath of shell solution or melt containing the polymer or precursor. As the device rotates and the stream moves through the air it breaks, due to Rayleigh instability, into droplets of core, each coated with the shell solution. While the droplets are in flight, the molten shell may be hardened or the solvent may be evaporated from the shell solution. If needed, the capsules can be hardened after formation by catching them in a hardening bath. Since the drops are formed by the breakup of a liquid stream, the process is only suitable for liquid or slurry. A high production rate can be achieved. Up to 22.5 kg of microcapsules can be produced per nozzle per hour and extrusion heads containing 16 nozzles are readily available.

Vibrational nozzle encapsulation method: polymer-encapsulation of ISE particles can be conducted using a laminar flow through a nozzle and vibration of the nozzle or the liquid. The vibration has to be done in resonance with the Rayleigh instability, leading to very uniform droplets. The liquid can include any liquids with limited viscosities (1-50,000 mPa·s): emulsions, suspensions or slurry containing the ISE active material particles and the polymer or precursor.

Spray-drying: Spray drying may be used to encapsulate ISE particles when the particles are suspended in a melt or polymer/precursor solution to form a suspension. In spray drying, the liquid feed (solution or suspension) is atomized to form droplets which, upon contacts with hot gas, allow solvent to get vaporized and thin shell of a polymer or precursor to fully embrace the particles.

Coacervation-phase separation: This process includes three steps carried out under continuous agitation:
(a) Formation of three immiscible chemical phases: liquid manufacturing vehicle phase, core material phase and encapsulation material phase. The ISE primary particles are dispersed in a solution of the encapsulating polymer or precursor. The encapsulating material phase, which is an immiscible polymer in liquid state, is formed by (i) changing temperature in polymer solution, (ii) addition of salt, (iii) addition of non-solvent, or (iv) addition of an incompatible polymer in the polymer solution.
(b) Deposition of encapsulation material: ISE particles being dispersed in the encapsulating polymer solution, encapsulating polymer/precursor coated around ISE particles, and deposition of liquid polymer embracing around ISE particles by polymer adsorbed at the interface formed between core material and vehicle phase; and
(c) Hardening of encapsulating shell material: shell material being immiscible in vehicle phase and made rigid via thermal, cross-linking, or dissolution techniques.

Interfacial polycondensation and interfacial cross-linking: Interfacial polycondensation entails introducing the two reactants to meet at the interface where they react with each other. This is based on the concept of the Schotten-Baumann reaction between an acid chloride and a compound containing an active hydrogen atom (such as an amine or alcohol), polyester, polyurea, polyurethane, or urea-urethane condensation. Under proper conditions, thin flexible encapsulating shell (wall) forms rapidly at the interface. A suspension of the ISE particles and a diacid chloride are emulsified in water and an aqueous solution containing an amine and a polyfunctional isocyanate is added. A base may be added to neutralize the acid formed during the reaction. Condensed polymer shells form instantaneously at the interface of the emulsion droplets. Interfacial cross-linking is derived from interfacial polycondensation, wherein cross-linking occurs between growing polymer chains and a multi-functional chemical group to form a polymer shell material.

In-situ polymerization: In some micro-encapsulation processes, the ISE particles are fully embedded in a monomer or oligomer first. Then, direct polymerization of the monomer or oligomer is carried out with the presence of these material particles dispersed therein.

Matrix polymerization: This method involves dispersing and embedding ISE primary particles in a polymeric matrix during formation of the particles. This can be accomplished via spray-drying, in which the particles are formed by evaporation of the solvent from the matrix material. Another possible route is the notion that the solidification of the matrix is caused by a chemical change.

The following examples are presented primarily for the purpose of illustrating the best mode practice of the present invention, not to be construed as limiting the scope of the present invention.

It may be noted that the more desirable and typical lithium ion conductivity of the polymer herein studied is from 10⁻⁶ S/cm to 1×10⁻² S/cm and that of the inorganic solid electrolyte (ISE) is from 10⁻⁶ S/cm to 5×10⁻² S/cm. The ISE-to-polymer electrolyte volume ratio can be from 1/100 to 100/1, but typically from 5/95 to 95/5, more typically from 10/90 to 90/10, furthermore typically from 20/80 to 80/20, and most typically from 30/70 to 70/30. The goal is to achieve a lithium ion conductivity of the polymer shell in the resulting hybrid electrolyte particulate from 10⁻⁵ S/cm to 5×10⁻² S/cm, preferably greater than 10⁻⁴ S/cm, and more preferably greater than 10⁻³ S/cm.

### Example 1: Preparation of Inorganic Solid Electrolyte (ISE) Powder, Lithium Nitride Phosphate Compound (LIPON)

Particles of Li₃PO₄ (average particle size 4 m) and urea were prepared as raw materials; g each of Li₃PO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (LIPON). The compound was ground in a mortar into a powder form. These ISE particles can be combined with a polymer to form hybrid solid-state electrolyte particulates for use in an anode, a cathode, and/or a separator.

### Example 2: Preparation of Solid Electrolyte Powder, Lithium Superionic Conductors with the Li₁₀GeP₂S₁₂ (LGPS)-Type Structure

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into pellets, placed into a graphite crucible, and then sealed at 10 Pa in a carbon-coated quartz tube. After being heated at a reaction temperature of 1,000° C. for 5 h, the tube was quenched into ice water. The resulting inorganic solid electrolyte material was then subjected to grinding in a mortar to form a powder sample to be later added as inorganic solid electrolyte particles encapsulated by an intended polymer electrolyte shell.

### Example 3: Preparation of Garnet-Type Inorganic Solid Electrolyte Powder

The synthesis of the c-Li_{6.25}Al_{0.25}La₃Zr₂O₁₂ was based on a modified sol-gel synthesis-combustion method, resulting in sub-micron-sized particles after calcination at a temperature of 650° C. (J. van den Broek, S. Afyon and J. L. M. Rupp, Adv. Energy Mater., 2016, 6, 1600736).

For the synthesis of cubic garnet particles of the composition c-Li_{6.25}Al_{0.25}La₃Zr₂O₁₂, stoichiometric amounts of LiNO₃, Al(NO₃)₃-9H₂O, La(NO₃)₃-6(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li_{6.25}Al_{0.25}La₃Zr₂O₁₂, which was ground to a fine powder in a mortar for further processing.

The c-Li_{6.25}Al_{0.25}La₃Zr₂O₁₂ solid electrolyte pellets with relative densities of ˜87±3% made from this powder (sintered in a horizontal tube furnace at 1070° C. for 10 h under 02 atmosphere) exhibited an ionic conductivity of ˜0.5×10⁻³ S cm⁻¹ (RT). The garnet-type solid electrolyte with a composition of c-Li_{6.25}Al_{0.25}La₃Zr₂O₁₂ (LLZO) in a powder form was encapsulated in several ion-conducting polymers.

### Example 4: Preparation of Sodium Superionic Conductor (NASICON) Type Inorganic Solid Electrolyte Powder

The Na_{3.1}Zr_{1.95}M_{0.05}Si₂PO₁₂ (M=Mg, Ca, Sr, Ba) materials were synthesized by doping with alkaline earth ions at octahedral 6-coordination Zr sites. The procedure employed includes two sequential steps. Firstly, solid solutions of alkaline earth metal oxides (MO) and ZrO₂ were synthesized by high energy ball milling at 875 rpm for 2 h. Then NASICON Na_{3.1}Zr_{1.95}M_{0.05}Si₂PO₁₂ structures were synthesized through solid-state reaction of Na₂CO₃, Zr_{1.95}M_{0.05}O_{3.95}, SiO₂, and NH₄H₂PO₄ at 1260° C.

### Example 5: Triblock Copolymer Poly(Styrene-Isobutylene-Styrene) or Sulfonated SIBS as an Elastic Polymer Shell Material

In one example, SIBS was dissolved in methylene chloride to form a thermoplastic elastomer/solvent solution. A desired amount of ISE particles (e.g., UPON prepared in Example 1) was then dispersed in the solution to produce the slurry, which was spray-dried to produce the hybrid solid electrolyte particulates.

Sulfonated SIBS was also investigated as an elastic polymer shell material since we have found that sulfonation could significantly increase the lithium-ion conductivity of SIBS. An example of the sulfonation procedure used in this study is summarized as follows: a 10% (w/v) solution of SIBS (50 g) and a desired amount of graphene oxide sheets (0.15 TO 405 by wt.) in methylene chloride (500 ml) was prepared. The solution was stirred and refluxed at approximately 40° C., while a specified amount of acetyl sulfate in methylene chloride was slowly added to begin the sulfonation reaction. Acetyl sulfate in methylene chloride was prepared prior to this reaction by cooling 150 ml of methylene chloride in an ice bath for approximately 10 min. A specified amount of acetic anhydride and sulfuric acid was then added to the chilled methylene chloride under stirring conditions. Sulfuric acid was added approximately 10 min after the addition of acetic anhydride with acetic anhydride in excess of a 1:1 mole ratio. This solution was then allowed to return to room temperature before addition to the reaction vessel.

After approximately 5 h, the reaction was terminated by slowly adding 100 ml of methanol. The reacted polymer solution was then precipitated with deionized water. The precipitate was washed several times with water and methanol, separately, and then dried in a vacuum oven at 50° C. for 24 h. This washing and drying procedure was repeated until the pH of the wash water was neutral. After this process, the final polymer yield was approximately 98% on average. This sulfonation procedure was repeated with different amounts of acetyl sulfate to produce several sulfonated polymers with various levels of sulfonation or ion-exchange capacities (IECs). The mol % sulfonation is defined as: mol %=(moles of sulfonic acid/moles of styrene)×100%, and the IEC is defined as the mille-equivalents of sulfonic acid per gram of polymer (mequiv./g).

After sulfonation and washing of each polymer, the S—SIBS samples were dissolved in a mixed solvent of toluene/hexanol (85/15, w/w) to form solutions having polymer concentrations ranging from 5 to 2.5% (w/v). Desired amounts of UPON particles prepared in Example 1 were added into these solutions and the resulting slurries were ultrasonicated for 0.5-1.5 hours. The slurry samples were separately spray-dried to form sulfonated SIBS elastomer-embraced particles.

### Example 6: Sulfonated and Un-Sulfonated Polybutadiene (PB) as an Elastomer Shell Material

Sulfonated PB may be obtained by free radical addition of thiolacetic acid (TAA) followed by in Situ oxidation with performic acid. A representative procedure is given as follows. PB (8.0 g) was dissolved in toluene (800 mL) under vigorous stirring for 72 h at room temperature in a 1 L round-bottom flask. Benzophenone (BZP) (0.225 g; 1.23 mmol; BZP/olefin molar ratio=1:120) and TAA (11.9 mL; 0.163 mol, TAA/olefin molar ratio=1.1) were introduced into the reactor and the polymer solution was irradiated for 1 h at room temperature with UV light of 365 nm and power of 100 W.

The resulting thio-acetylated polybutadiene (PB-TA) was isolated by pouring 200 mL of the toluene solution in a plenty of methanol and the polymer recovered by filtration, washed with fresh methanol, and dried in vacuum at room temperature. Formic acid (117 mL; 3.06 mol; HCOOH/olefin molar ratio=25), along with a desired amount of and a desired amount of inorganic solid electrolyte particles (0.1%⁻⁴⁰% by wt.) prepared in Examples 1 and 2, from 10 to 100 grams) were added to the toluene solution of PB-TA at 50° C. followed by slow addition of 52.6 mL of hydrogen peroxide (35 wt %; 0.61 mol; H₂O₂/olefin molar ratio=5) in 20 min. We would like to caution that the reaction is autocatalytic and strongly exothermic. The resulting slurry was spray-dried to obtain sulfonated polybutadiene-encapsulated ISE particulates.

### Example 7: Sulfonated and Un-Sulfonated Styrene-Butadiene-Styrene Triblock Copolymer (SBS) as an Elastic Polymer Shell Material

Sulfonated styrene-butadiene-styrene triblock copolymer (SBS) based elastomer was directly synthesized. First, SBS was first epoxidized by performic acid formed in situ, followed by ring-opening reaction with an aqueous solution of NaHSO₃. In a typical procedure, epoxidation of SBS was carried out via reaction of SBS in cyclohexane solution (SBS concentration=11 g/100 mL) with performic acid formed in situ from HCOOH and 30% aqueous H₂O₂ solution at 70° C. for 4 h, using 1 wt % poly(ethylene glycol)/SBS as a phase transfer catalyst. The molar ratio of H₂O₂/HCOOH was 1. The product (ESBS) was precipitated and washed several times with ethanol, followed by drying in a vacuum dryer at 60° C.

Subsequently, ESBS was first dissolved in toluene to form a solution with a concentration of 10 g/100 mL, into which was added 5 wt % TEAB/ESBS as a phase transfer catalyst and 5 wt % DMA/ESBS as a ring-opening catalyst. Herein, TEAB=tetraethyl ammonium bromide and DMA=N,N-dimethyl aniline. An aqueous solution of NaHSO₃ and Na₂SO₃ (optionally along with graphene sheets, if not added earlier) was then added with vigorous stirring at 60° C. for 7 h at a molar ratio of NaHSO₃/epoxy group at 1.8 and a weight ratio of Na₂SO₃/NaHSO₃ at 36%. This reaction allows for opening of the epoxide ring and attaching of the sulfonate group according to the following reaction:

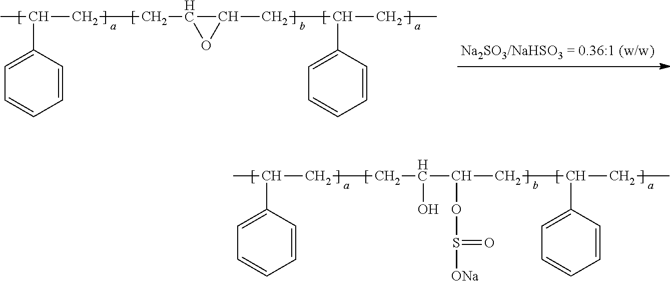

The reaction was terminated by adding a small amount of acetone solution containing antioxidant. The mixture was washed with distilled water three times, then precipitated by ethanol, followed by drying in a vacuum dryer at 50° C. It may be noted that particles of an inorganic solid electrolyte (ISE particles prepared in Example 3) may be added during various stages of the aforementioned procedure (e.g., right from the beginning, or prior to the ring opening reaction). Preferably, the ISE is added after the ring opening reaction.

The lithium-ion cells prepared in this example comprise an anode of graphene-protected Si particles, a cathode of NCM-622 particles, SBS-encapsulated ISE particles, and a porous PE/PP membrane as a separator.

### Example 8: Polyisoprene Elastomer-Encapsulated ISE Particulates

A dilute elastomer-solvent solution (0.01-0.1 M of cis-polyisoprene in cyclohexane and 1,4-dioxane) was prepared as a coating solution. Subsequently, lithium hexafluoro phosphate, as a lithium salt, was added and dissolved in the above solution. An air-suspension method (fluidized bed process) was then used to produce elastomer-encapsulated ISE particles (prepared in Example 4). The resulting particulates have a shell thickness of 2.3 nm to 124 nm.

A lithium metal cell was made, comprising a lithium metal foil as the anode active material, a cathode (comprising 75% by weight of LiCoO₂ as the cathode active material, 15% of hybrid particulates, 5% PVDF binder, and 5% combined graphene/CNT as a conductive additive), and a solid-state electrolyte-based separator composed of particles of Li₇La₃Zr₂O₁₂ embedded in a poly(vinylidene fluoride)-hexafluoropropylene (PVDF-HFP) matrix (inorganic solid electrolyte/PVDF-HFP ratio=4/6).

### Example 9: High-Elasticity, Thermally Stable Polymer-Encapsulated ISE Particulates

For the preparation of the elastic polymer, a 1-liter flask equipped with a thermometer, a stirrer, a dropping funnel and a condenser was charged with 100 ml of tetrahydrofuran and 11.6 g (0.5 mole) of metallic sodium. To this mixture was dropwise added 55.5 g (0.55 mole) of 2,2,2-trifluoroethanol, and the mixture was then reacted under reflux until sodium was completely consumed. To this reaction mixture was dropwise added a solution of 39.6 g (0.111 mole) of hexachlorotriphosphazene in 100 ml of toluene, and the mixture was reacted under reflux for 2 hours. Thereafter, the temperature of the reaction mixture was dropped to room temperature and 191 g (1.47 mole) of HEMA was dropwise added to the reaction mixture slowly using the dropping funnel. The mixture was then heated to 60° C. and the reaction was continued for 8 hours at that temperature with stirring. Thereafter, precipitated crystalline materials and the catalyst were filtered off and the solvent in the filtrate was distilled off under reduced pressure. The residual solution was a curable phosphazene compound in the form of a solution having a yellow color.

A benzol peroxide initiator (0.5% by weight relative to the curable compound), the curable phosphazene compound, 3⁻¹²% of lithium hexafluoro phosphate as a lithium salt, and ISE particles prepared in Examples 2 and 3, respectively, were dispersed in toluene to form a slurry. Upon spray-drying, the resulting micro-droplets were heated at 65° C. overnight to obtain the hybrid solid electrolyte particulates comprising ISE particles encapsulated by a high-temperature elastic polymer.

Separately, the micro-droplets were compacted to form several thin sheets (11⁻²⁵ μm in thickness) which were cured to obtain layers of cross-linked polymers that could be used as a hybrid solid electrolyte separator. Tensile testing was also conducted on these layers. This series of cross-linked polymers can be elastically stretched up to approximately 35% (higher degree of cross-linking) to 188% (lower degree of cross-linking).

### Example 10: Poly[Bis(2-Hydroxyethyl-Methacrylate)-Phosphazene] as the Encapsulating Polymer

Poly[bis(2-hydroxyethyl-methacrylate)-phosphazene] was obtained by nucleophilic condensation reactions at different concentrations of the substituents. Specifically, the scheme of the poly(organophosphazenes) synthesis by nucleophilic substitution is shown in Reaction 1 earlier. The single substituted and co-substituted poly(dichlorophosphazenes) (PZs) were obtained from poly(dichlorophosphazene) by melt ring-opening polymerization of hexachlorocyclotriphosphazene (HCCP) under vacuum at 250° C. for 3 h. After this time, the polymer was dissolved at room temperature in anhydrous THF, and it was separated by precipitation into n-heptane.

The substitution of poly(dichlorophosphazene) (PZ) with pentaerythritol triacrylate (PEATA) was made at two molar ratios: 1:3 and 1:6 mmol PZ-PEATA. Triethylamine (TEA) was added at 1:1 mmol ratio PEATA: TEA as an effective acceptor to trap hydrogen chloride. The PZ was dissolved in THF (10 mL) under stirring and, after 10 min, PEATA and TEA were added. Subsequently, the glass vial reactor was kept for two days at room temperature. The product was purified following the procedure described for PZ.

A methyl amine initiator (0.5% by weight relative to the curable compound), the as-obtained curable phosphazene compound, 0.6 M LiTFSI and 0.4 M LiDFOB as lithium salts, and ISE particles (prepared in Examples 3⁻⁴) were dispersed in toluene to form a slurry. The slurry was cured and dried in a vacuum oven at 65° C. overnight to obtain the powder of hybrid solid electrolyte particulates.

### Example 11: A Polyphosphazene [NP(NHR)₂]ₙ with Oligo[Propylene Oxide] Side Chains —R=—[CH(CH₃)—CH₂O]ₘ—CH₃ (m=6-10) as an Encapsulating Polymer

A high-elasticity polyphosphazene polymer was prepared from [NPCl₂]ₙ and a propylene oxide oligomer according to the following reaction:

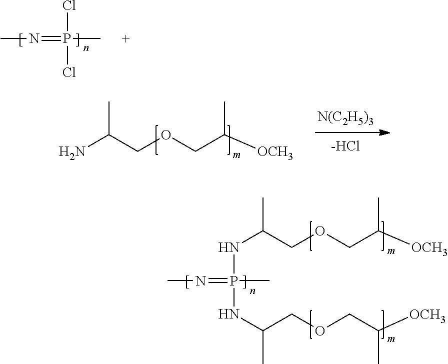

In a representative procedure, 4.69 g of [NPCl₂]ₙ were dissolved in 200 ml of anhydrous THF to form a polymer solution. Then, 11.3 ml of triethyl amine (TEA) and 50 ml of propylene oxide oligomer were then added to the polymer solution. The resulting reaction mixture was stirred for 24 h at room temperature. The solvent was then removed under vacuum yielding a highly viscous yellowish polymer solution which was dialyzed against water for 5 days. Removal of water after dialysis yielded a slightly yellowish, highly viscous polymer. This polymer, after mixing with ISE particles (prepared in Examples 2⁻³), was cross-linked by UV radiation in the presence of dissolved benzophenone as photoinitiator.

Cross linking was carried out as follows: 0.5 g of the as-obtained viscous polymer was dissolved in 4 ml freshly distilled THE. Up to 10 mol. % of benzophenone was then added and the solution was stirred for 1_h. Particles of an ISE were then added to the solution to form a slurry. Finally, it was poured into a glass container and dried in an oven at 60° C. for 48 h. The material was irradiated under inert atmosphere with an unfiltered UV light source for 15 min at a distance of 7 cm (low-pressure mercury lamp, 500 W). With some simple grinding, one obtained powder of composite particulates.

On a separate basis, neat polymer films containing no ISE particles were prepared under comparable conditions for tensile testing. This series of cross-linked polymers can be elastically stretched up to approximately 35% (higher degree of cross-linking) to 311% (lower degree of cross-linking).

### Example 12: Poly[Bis 2-(2-(2-Methoxyethoxy)Ethoxy)Ethoxyphosphazene] (MEEEP)

A polyphosphazene based electrolyte membranes consisting of a linear polymer with —(N=PR₂)— units, grafted with ethylene oxide side chains of the type R=—(OCH₂CH₂)₃OCH₃ was prepared according to the following reaction:

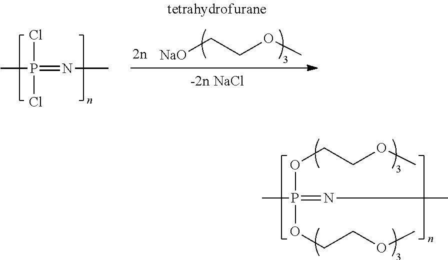

As a representative procedure, 3.6 g (150 mmol) of sodium hydride was suspended in 120 mL tetrahydrofurane and cooled to 0° C. The freshly distilled 2-(2-(2-methoxyethoxy)ethoxy)ethanol was added drop wise and the suspension was stirred for 1 h under hydrogen gas evolution. Then 8.7 g (74.9 mmol) of precursor polymer (—(N=PR₂)—) dissolved in 50 mL tetrahydrofurane was added to the meanwhile clear solution and stirred for 24 h, while sodium chloride precipitated. Excess solvent was removed in a rotary evaporator. The product was purified in a dialysis tube against distilled water. After a final evaporation of water and drying at 50° C. under vacuum for 2 h, one obtained the highly viscous, yellow honey like poly[bis(2-(2-(2-methoxyethoxy) ethoxy)ethoxy phosphazene)] (MEEEP).

A solution of MEEEP in tetrahydrofurane was added with 5 wt % benzophenone to form a solution. A desired amount of ISE particles (prepared in Examples 1⁻²) was allowed to dip into the solution for 10⁻³⁰ seconds and then retreated. After this dip-coating procedure, the coated particles were sprayed onto a glass surface. The powder was exposed to UV-irradiation for 20 minutes. Using 5 wt. % benzophenone, a cross-linking degree of 10% was obtained with reference to the monomer units (—NPR₂—). All samples were dried again after cross-linking for at least 48 h at 70° C. and then stored in a glove box under dry argon prior to use.

1. A hybrid solid electrolyte particulate for use in a rechargeable lithium battery cell, wherein said particulate comprises one or more than one inorganic solid electrolyte particles encapsulated by a shell of elastic polymer electrolyte wherein (i) the hybrid solid electrolyte particulate has a lithium-ion conductivity from 10⁻⁶ S/cm to 5×10⁻² S/cm and both the inorganic solid electrolyte and the elastic polymer electrolyte individually have a lithium-ion conductivity no less than 10⁻⁶ S/cm; (ii) the elastic polymer electrolyte-to-inorganic solid electrolyte ratio is from 1/100 to 100/1 or the elastic polymer electrolyte shell has a thickness from 1 nm to 10 μm; and (iii) the elastic polymer electrolyte has a recoverable elastic tensile strain from 5% to 1,000%.

2. The hybrid solid electrolyte particulate of claim 1, wherein the inorganic solid electrolyte material is selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof.

3. The hybrid solid electrolyte particulate of claim 1, wherein the elastic polymer electrolyte comprises a material selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyurethane, urethane-urea copolymer, polyphosphazene, a copolymer thereof, a sulfonated version thereof, or a combination thereof.

4. The hybrid solid electrolyte particulate of claim 1, wherein the elastic polymer electrolyte further comprises a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, poly(alkylsiloxane), poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyacrylamide, a polyionic liquid, polymerized 1,3-dioxolane, polyepoxide ether, polysiloxane, poly(dimethyl siloxane), poly(alkyl siloxane), poly(acrylonitrile-butadiene), polynorbornene, poly(hydroxyl styrene), poly(ether ketone), polypeptoid, poly(ethylene-maleic anhydride), polycaprolactone, poly(trimethylene carbonate), a crosslinked polymer containing chains of ethylene glycol phenyl ether acrylate) (PEGPEA) or ethoxylated trimethyl propyl triacrylate (ETPTA), poly(phosphate), poly(phosphonate), poly(phosphinate), poly(phosphine), poly(phosphine oxide), poly(phosphonic acid), poly(phosphorous acid), poly(phosphite), poly(phosphoric acid), poly(phosphazene), a chemical derivative thereof, a copolymer thereof, a sulfonated derivative thereof, or a combination thereof, wherein said ion-conducting polymer and the elastic polymer form a polymer blend, a copolymer, a crosslinked network of chains, a semi-interpenetrating network, or a simultaneous interpenetrating network.

5. The rechargeable lithium cell of claim 1, wherein the elastic polymer electrolyte further comprises 0.1%⁻⁶⁰% by weight of a lithium salt dispersed therein.

6. The hybrid solid electrolyte particulate of claim 5, wherein the lithium salt is selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0⁻¹, y=1⁻⁴, or a combination thereof.

7. A rechargeable lithium cell comprising an anode, a cathode, and a separator disposed between the anode and the cathode, wherein at least one of the anode, the cathode, and the separator comprises multiple hybrid solid electrolyte particulates as defined in claim 1.

8. The rechargeable lithium cell of claim 7, wherein:
the hybrid solid electrolyte particulates comprise a 1^{st} elastic polymer electrolyte encapsulating inorganic solid electrolyte particles;
the anode comprises multiple anode particulates comprising anode active material particles encapsulated by a 2^{nd} elastic polymer electrolyte, wherein the 1 s elastic polymer electrolyte and the 2^{nd} elastic polymer electrolyte are identical or different in chemical composition or structure; and
the hybrid solid electrolyte particulates and the anode particulates are compacted or consolidated to form the anode.

9. The rechargeable lithium cell of claim 8, further including a conductive additive that is compacted or consolidated with said hybrid solid electrolyte particulates and said anode particulates to form said anode.

10. The rechargeable lithium cell of claim 7, wherein:
the hybrid solid electrolyte particulates comprise a 1^{st} elastic polymer electrolyte encapsulating inorganic solid electrolyte particles;
the cathode comprises multiple cathode particulates each comprising cathode active material particles encapsulated by a 2^{nd} elastic polymer electrolyte, wherein the 1 s elastic polymer electrolyte and the 2^{nd} elastic polymer electrolyte are identical or different in chemical composition or structure; and
the hybrid solid electrolyte particulates and the cathode particulates are compacted or consolidated to form the cathode.

11. The rechargeable lithium cell of claim 10, further including a conductive additive that is compacted or consolidated with said hybrid solid electrolyte particulates and said cathode particulates to form said cathode.

12. The rechargeable lithium cell of claim 7, wherein the cathode comprises a cathode active material selected from lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

13. The rechargeable lithium cell of claim 7, which is a lithium-ion cell wherein the anode comprises an anode active material selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCO₂O₄; (f) carbon or graphite particles (g) prelithiated versions thereof; and (h) combinations thereof.

14. The rechargeable lithium cell of claim 7, which is a lithium metal secondary cell, a lithium-ion cell, a lithium-sulfur cell, a lithium-ion sulfur cell, a lithium-selenium cell, or a lithium-air cell.

15. A powder product comprising multiple hybrid solid electrolyte particulates as defined in claim 1.

16. An anode comprising a mixture of multiple anode active material particles and multiple hybrid solid electrolyte particulates as defined in claim 1.

17. The anode of claim 16, wherein the multiple hybrid solid electrolyte particulates each comprising one or a plurality of the inorganic solid electrolyte particles encapsulated by a 1^{st} elastic polymer electrolyte and wherein the anode comprises multiple anode particulates each comprising one or a plurality of the anode active material particles encapsulated by a 2^{nd} elastic polymer electrolyte, wherein the 1^{st} elastic polymer electrolyte and the 2^{nd} elastic polymer electrolyte are identical or different in chemical composition or structure.

18. A cathode comprising a mixture of multiple cathode active material particles and multiple hybrid solid electrolyte particulates as defined in claim 1.

19. The cathode of claim 18, wherein the multiple hybrid solid electrolyte particulates each comprising one or a plurality of the inorganic solid electrolyte particles encapsulated by a 1^{st} elastic polymer electrolyte and wherein the cathode comprises multiple cathode particulates each comprising one or a plurality of the cathode active material particles encapsulated by a 2^{nd} elastic polymer electrolyte, wherein the 1^{st} elastic polymer electrolyte and the 2^{nd} elastic polymer electrolyte are identical or different in chemical composition or structure.

20. A process for producing a plurality of the hybrid solid electrolyte particulates as defined in claim 1, said process comprising:
(A) dispersing a plurality of primary particles of an inorganic solid electrolyte, having a diameter or thickness from 1 nm to 20 m, in a reactive liquid mixture of (i) a monomer, oligomer, or cross-linkable polymer as a precursor to the elastic polymer and (ii) an initiator and/or a cross-linking agent to form a reactive slurry;
(B) forming the reactive slurry into micro-droplets; and
(C) polymerizing and/or curing the monomer, the oligomer or the cross-linkable polymer in said micro-droplets to form the hybrid solid electrolyte particulates.

21. The process of claim 20, wherein said step (B) of forming micro-droplets comprises a procedure selected from pan-coating, air-suspension coating, centrifugal extrusion, vibration-nozzle encapsulation, spray-drying, kneadering, casting and drying, coacervation-phase separation, interfacial polycondensation or interfacial cross-linking, in-situ polymerization, matrix polymerization, extrusion and palletization, or a combination thereof.

22. The process of claim 20, wherein said micro-droplets contain water or a liquid solvent and the process further comprises a step of removing said water or solvent.

23. The process of claim 20, further comprising a step of combining said hybrid solid electrolyte particulates, particles of an anode active material, and a conductive additive into an anode electrode; or combining said hybrid solid electrolyte particulates, particles of a cathode active material, and a conductive additive into a cathode electrode.

24. The process of claim 20, further comprising a step of combining and consolidating said hybrid solid electrolyte particulates to form a solid electrolyte separator.

25. A process for producing a plurality of the hybrid solid electrolyte particulates as defined in claim 1, said process comprising:
a) dispersing a plurality of primary particles of an inorganic solid electrolyte, having a diameter or thickness from 1 nm to 20 m, in a liquid solution, comprising an elastic polymer dispersed or dissolved in a liquid solvent, to form a slurry;
b) forming the slurry into micro-droplets; and
c) removing the liquid solvent in said micro-droplets to form the hybrid solid electrolyte particulates.

26. The process of claim 25, wherein said step (B) of forming micro-droplets comprises a procedure selected from pan-coating, air-suspension coating, centrifugal extrusion, vibration-nozzle encapsulation, spray-drying, extrusion and palletization, kneadering, or a combination thereof.

27. The process of claim 25, further comprising a step of combining and consolidating said hybrid solid electrolyte particulates to form a solid electrolyte separator.

28. The process of claim 20, further comprising a step of combining and consolidating (i) said hybrid solid electrolyte particulates having a 1^{st} elastic polymer electrolyte encapsulating inorganic solid electrolyte particles and (ii) anode or cathode active material particles encapsulated by a 2^{nd} elastic polymer electrolyte to form an anode or cathode electrode, wherein the 1^{st} elastic polymer electrolyte and the 2^{nd} elastic polymer electrolyte are identical or different in chemical composition or structure.

29. The process of claim 28, further including a conductive additive also encapsulated by a 2^{nd} elastic polymer electrolyte with said anode or cathode active material particles to form said anode or cathode electrode.

30. The process of claim 25, further comprising a step of combining and consolidating (i) said hybrid solid electrolyte particulates having a 1^{st} elastic polymer electrolyte encapsulating inorganic solid electrolyte particles and (ii) anode or cathode active material particles encapsulated by a 2^{nd} elastic polymer electrolyte to form an anode or cathode electrode, wherein the 1^{st} elastic polymer electrolyte and the 2^{nd} elastic polymer electrolyte are identical or different in chemical composition or structure.

31. The process of claim 30, further including a conductive additive also encapsulated by a 2^{nd} elastic polymer electrolyte with said anode or cathode active material particles to form said anode or cathode electrode.
